(19) United States
(12) Patent Application Publication
(10) Pub. No.: US 2005/0160150 A1
(43) Pub. Date: Jul. 21, 2005

(54) Apparatus and method for managing and transporting virtual disks over a network to networked stations

(76) Inventor: Su-Hwa Kao, Sindian City (TW)

Correspondence Address: SUPREME PATENT SERVICES, POST OFFICE BOX 2339, SARATOGA, CA, 95070, US

(21) Appl. No.: 10/760,011

(22) Filed: Jan. 20, 2004

(51) Int. Cl. G06F 15/167

(52) U.S. Cl. 709/212

(57) ABSTRACT

An apparatus and method for managing and transporting virtual disks over a network to networked stations is disclosed. The apparatus comprises a data storage subsystem and a data processor connected thereto via a network. The data processor includes a virtual disk interface controller to interface with the storage subsystem in handling the input and output for the storage subsystem. The storage subsystem manages a pool of storage blocks in the form of a plurality of virtual disk images and transports the virtual disk images over the network to the virtual disk interface controller. A virtual disk image is emulated as a virtual disk by the virtual disk interface controller and presented to the data processor. The architecture for management and delivery of disk images and the data structure for maintenance of disk images facilitate software deployment and installation onto the networked diskless computers enable highly efficient system administration on the whole network to maximize the network availability.

### FIELD OF THE INVENTION

The present invention generally relates to the data processing in a network environment, and more specifically to an apparatus and method for managing and transporting virtual disks over a network to networked stations.

### BACKGROUND OF THE INVENTION

Nowadays data processing network system has become indispensable in daily operation of an enterprise or an organization. The data processing network system is prevalently based on the client-server model as shown in FIG. 1. A plurality of computers known as user nodes (the clients) 101˜10n and a plurality of computers known as application server nodes (the servers) are connected by a message transporting media, such as the dominant Ethernet bus, to form a network 120. The client computers 101˜10n and an application server computer 130 are connected through the network 120. The application storage device 140 containing application server software and enterprise data is connected to the application server computer 130. Thereby, it allows data communication between connected nodes to accomplish data processing purposes.

As referred to 101˜10n, each connected client or server node is usually equipped with a directly attached storage device (DASD), also popularly known as a disk, for temporary or permanent storage of application client software, productively tools and user data. The node has to access the software and data during system bootstrapping and during the after-boot operation.

Upkeep of the data processing network system is the main goal of system administration in an enterprise or organization. The goal is achieved by accomplishing tasks of setting up the network with connected client and server nodes, installing necessary software (operating systems and application programs) with proper configuration on the newly connected node to make it operable, repeating software installation process on the rest client nodes, updating nodes with newer version of software, managing software versions on each node, maintaining the network in operable condition by ensuring system/data integrity and hardware robustness for each node, and supporting users' ad hoc requests for restoration/recovery of client systems to their state of integrity.

In performing the above-mentioned tasks, system administration constantly has to deal with the following problems. Long and sometimes repetitive process of restoring system to its previous state of integrity is required before a software package is successfully installed on a node. Efforts of rolling software back to its previous version that is found preferable or more reliable are made only after the newer version has been deployed for field use. Long deployment process is performed in propagating desirable installation of software with configuration to hundreds or thousands of client nodes in the enterprising network. Field support is provided for system restoration or reinstallation on client nodes that fail to boot after digressing from operable states due to erroneous configuration such as improper device setting.

All these scenarios translate into some kind of management cost that adds to high total cost of network ownership. Analysis has shown that software-related services (support, distribution/installation, updating, and administration) make up the largest part of total personal computer (PC) software costs while the cost of acquiring the software accounts for only a small portion of these total costs. Users have no easy access for solving such problems as local disk failure. Support calls are usually required.

In view of the foregoing, it would be desirable and beneficial to provide a networking facility via which a computer node can be easily introduced into the network, either during initial setup stage or as a replacement of a failed node, with required software properly installed and configured so that a user would suffer minimal amount of holding before she or he is able to begin productive computing-related work.

A further desirable feature would be easy restoration of a node, after system corruption that results in failure to boot the system or launch application software, to its prior working state of integrity. Another desirable feature with similar benefit would be easy and effortless fallback of the system to its prior state of integrity in case of unsuccessful software installation or configuration.

In accordance with the above problems, system administration desires data processing network system with functions of easy system fallback to the latest state of integrity in the event of unsuccessful software installation or configuration, easy introduction of a client into the system, automated easy deployment of software to all nodes via network, user self-maintained system integrity for keeping technical support to its minimum level, user-initiated system recovery, effective software version management on each node, support of system tuning of group performance in terms of disk accessing and system (OS and application) launching.

Various techniques have been devised to partially address the problems related to software installation and distribution on client nodes. In one technique, procedures based on carefully designed installation script are executed to automatically put software onto each client's local disk over the network. Another technique focuses on one-time installation of a centrally managed set of client software stored on a deployment server and, after that, copies of said software images can be transported via the network to multiple target client computers for installation on their respective local disks. These techniques also provide solutions for system recovery on client computers that failed to boot up, by doing a lengthy fresh installation. These solutions can be extended beyond just a specific set of software to encompass multiple sets of software each would be made commonly available to a specific user group of a network. The intent of such doing would be to condense the administration of the software required by and installed on every single client of that group into a one-time work.

To address problems caused by local disk failure, prevailing solutions are diskless clients that replace local disks with network disks, remote disks or network file systems for storage of software and data to be accessed by the clients. Remote boot means are further implemented to perform system bootstrapping that is usually provided by the local disk. In accordance with remotely bootable diskless clients operating on network-based storages, field technical support efforts are minimized for system restoration or replacement for failed local disk. Many of the cited references provide solutions of these categories, such as U.S. Pat. No. 6,047,129, U.S. Pat. No. 6,075,943 and U.S. Pat. No. 5,931,909 for software installation, and U.S. Pat. No. 5,146,568, U.S. Pat. No. 5,974,547 and U.S. Pat. No. 5,842,011 for remote booting.

In one category referred as the “server-based installation” approach, the set of software images is downloaded and installed in each and every client computer's local storage device according to specified installation and configuration scripts. FIG. 2 shows a conventional server-based installation environment. The application server 130 and an installation storage device 201 are connected through the network 120. The installation storage device 201 is connected to the installation sever 202. The installation storage device 201 contains client software (O/S and client applications) to be downloaded by client computers for installation on their respective disks. The installation storage device 201 also contains installation tools such as executable scripts to facilitate installation process. Each client subsequently operates based on the software that has been installed on its storage device.

In another category referred as the “server-based computing” approach, the pre-installed software is downloaded to and executed on a powerful network server with user interfaces (namely the screen display and the keyboard and mouse input) delivered via the network to be handled by a less powerful “thin-client” computer. FIG. 3 shows a conventional server-based computing environment. A plurality of thin-client terminals 301˜30n, the application server 130 and a terminal server 312 are connected through the network 120. The terminal server's storage device 313 stores client software (O/S, productivity tools and application client software) to be executed on the terminal server 312 on behalf of each thin client terminal. No local storage device is attached to each thin client terminal which only executes simple software to handle, beside terminal input/output functions, communication between a corresponding client session being executed on the terminal server 312 which runs a redirection software to route the input/output messages from and to the client session.

Despite plausible reduction of administrative costs, these approaches have their inherent drawbacks. The “server-based installation” approach relies on storage devices directly attached to each client for holding client software and therefore is not immune from disk-caused system failures. The thin client in the “server-based computing” approach usually requires no local disk and is immune from disk-caused system failures, while at the expense of shifting data processing to a network server. The total processing load required of the server or servers could easily render this approach impractical in a large enterprise IT environment.

As disclosed in U.S. Pat. No. 5,668,943 and U.S. Pat. No. 5,794,052, the thin-client architecture tries to simultaneously address the problems related to software installation/distribution and failed-disk recovery support. A thin client is a diskless stripped-down computer remotely bootable by a server and operating on centrally installed and managed software. A major drawback of the thin-client architecture is its requirement for powerful terminal servers for support of the clients' graphical user interface (GUI), along with extra demand for communication bandwidth to transport GUI messages between terminal servers and thin clients, in spite of clever protocols designed to reduce the network traffic. One such protocol is the Citrix's Independent Computing Architecture (ICA) protocol. But one critical drawback is that such solutions always deliver a set, or at most a few sets, of homogeneous computing platforms to the users. Dynamic reconfiguration of a computing platform always requires system administrator's support.

There has been a strong need in developing an easy and effective apparatus and method for performing system administration tasks in a huge enterprise computing environment.

### SUMMARY OF THE INVENTION

The present invention has been made to meet the need of a highly efficient apparatus and method which has a novel architecture for management and delivery of disk images and a special data structure for maintenance of disk image integrity, facilitate software deployment and installation onto the networked diskless computers. As a result, it enables highly efficient system administration on the whole network to maximize the network availability.

An object of the invention is to provide an apparatus for managing and transporting virtual disks over a network to networked stations. The apparatus comprises a data storage subsystem and a data processor connected thereto via a network. The data processor includes a virtual disk interface controller to interface with the storage subsystem in handling the input and output for said storage subsystem. The storage subsystem manages a pool of storage blocks in the form of a plurality of virtual disk images and transports the virtual disk images over the network to the virtual disk interface controller. Each virtual disk image is emulated as a virtual disk by said virtual disk interface controller and presented to said data processor.

In the invention, each disk emulator serves as a local disk device to its host computer, and a disk image is transparently subject to hard disk manipulation utilities for making partitions, creating file system or configuring for bootstrapping. The disk image functions in the same way as the local hard disk without noticeable difference to the computer that hosts the disk emulation adaptor. The disk emulation adaptor communicates with the disk image server via a network protocol for transporting packets that encapsulate disk access requests and results.

With the architecture, the present invention facilitates setup and maintenance of operation environments residing in the failure-prone storage devices that are by convention directly attached to each personal computer. It also facilitates software installation, system fallback and system recovery.

Another object of the invention is to provide the method for managing and transporting virtual disks over a network to networked stations. It comprises the steps of managing a pool of possibly scattered and shared storage blocks in the form of a plurality of virtual disk images, transporting selected virtual disk images over the network to a plurality of connected diskless computers and seamlessly emulating the transported virtual disk image as a hard disk to the computer that requests access to the virtual disk image.

Accordingly, this method provides a scheme for remotely controlling the processing and configuration of networked computers from a central common location, specifically that of the network system administrator.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a data processing network system prevalently based on a conventional client-server model.

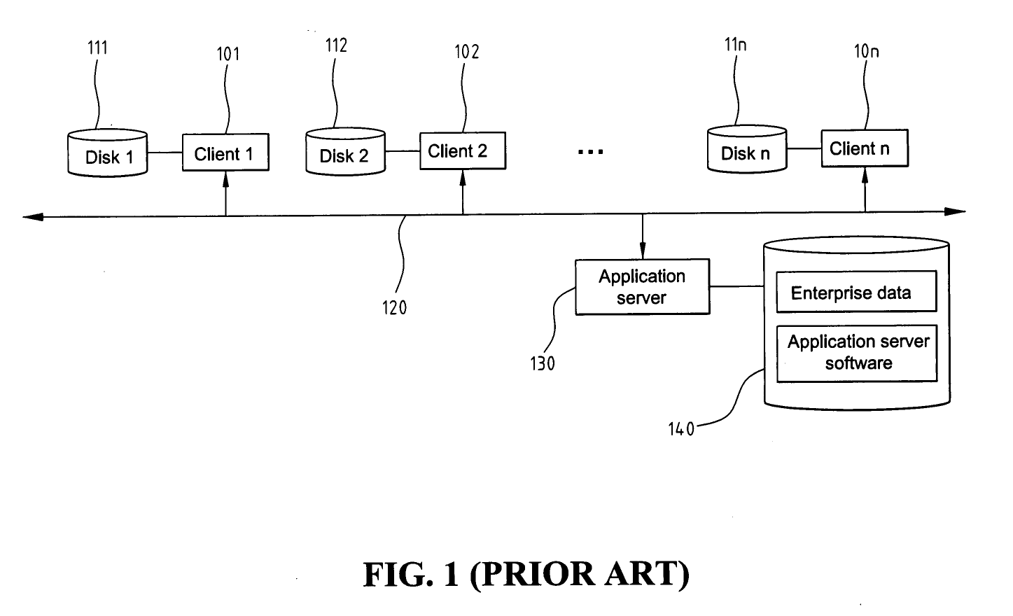

FIG. 2 shows a conventional server-based installation environment.

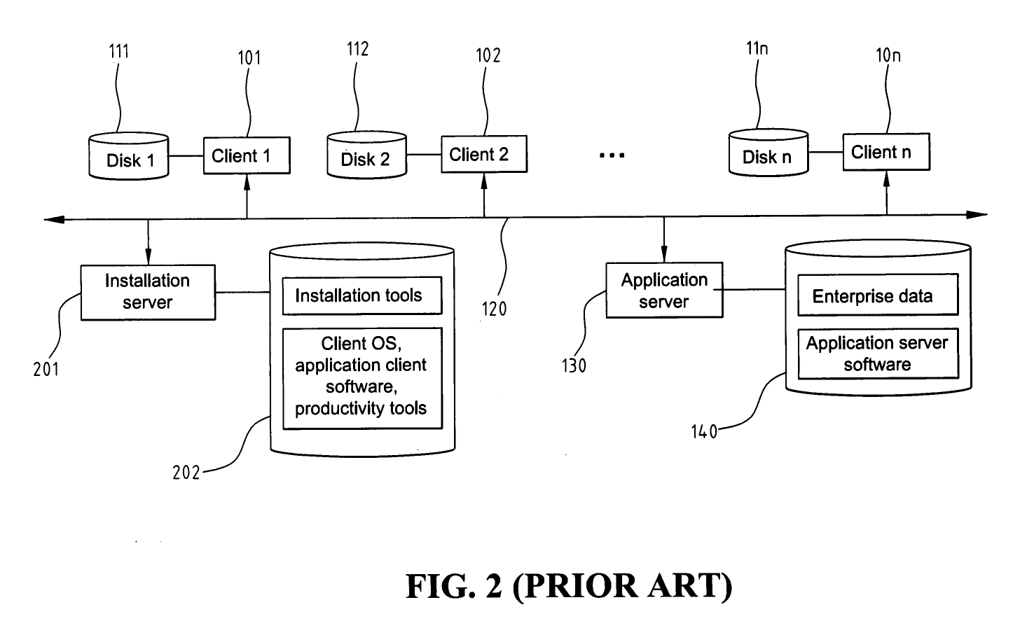

FIG. 3 shows a conventional server-based computing environment.

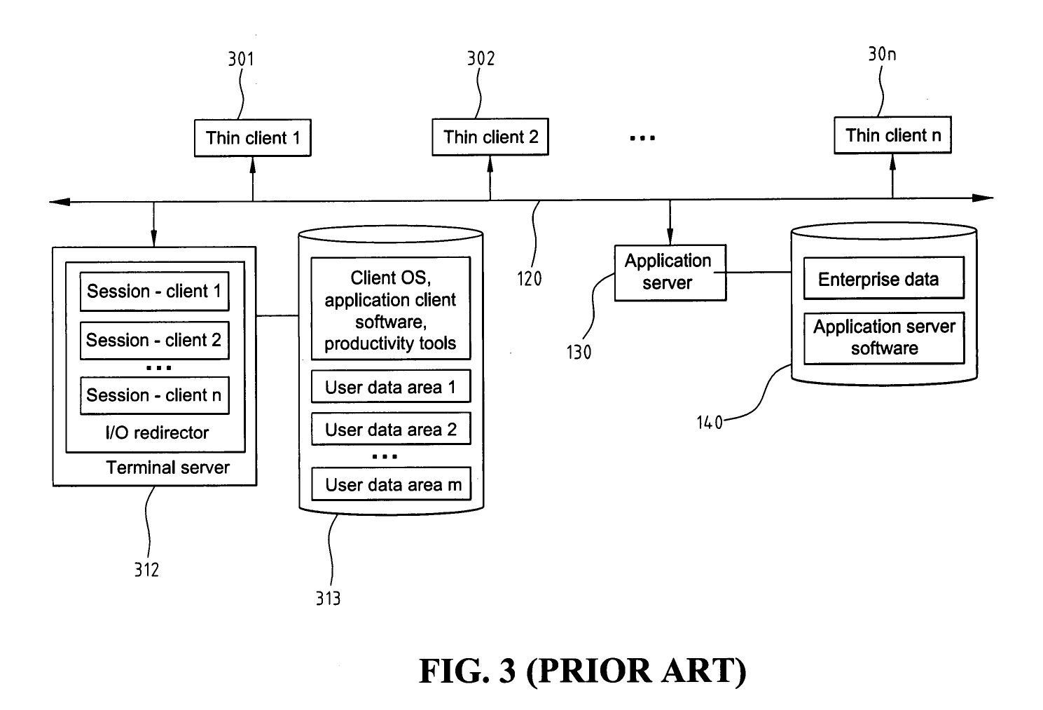

FIG. 4 shows the schematic diagram of the apparatus for managing and transporting virtual disks over a network to networked stations according to the invention.

FIG. 5 shows a more detailed diagram for the virtual disk interface controller according to the present invention.

FIG. 6 shows a simplified representative diagram for the data processor according to the present invention.

FIG. 7 shows the steps for managing and transporting virtual disks over a network to networked stations of the present invention.

FIG. 8 shows a PC boot process.

### DETAILED DESCRIPTION OF THE PREFERRED EMBODIMENTS

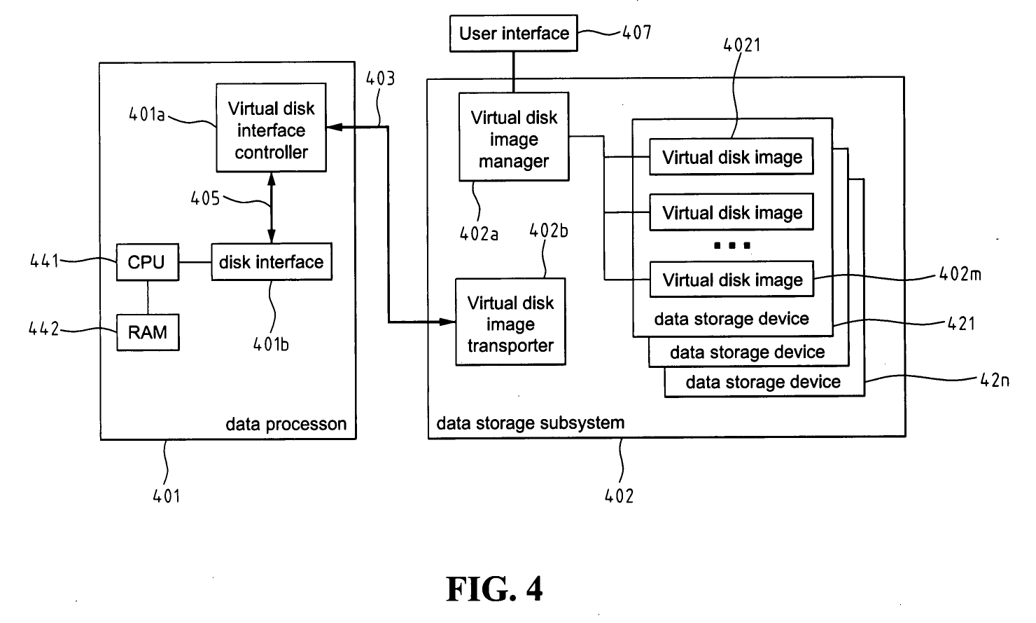

In the preferred embodiment of the present invention, an apparatus is provided for managing and transporting virtual disks over a network to networked stations. FIG. 4 illustrates the schematic diagram of the apparatus for managing and transporting virtual disks over a network to networked stations according to the invention.

Referring to FIG. 4, the apparatus comprises a data storage subsystem 402 and at least one data processor 401 connected thereto via a network 403. For easy reference, only a data processor is shown in FIG. 4. The data processor 401 includes a virtual disk interface controller 401a to interface with the storage subsystem 402 in handling the input and output for the storage subsystem 402. The storage subsystem 402 manages a pool of storage blocks in the form of a plurality of virtual disk images and transports the virtual disk images over the network 403 to the virtual disk interface controller 401a. A virtual disk image transported via the network 403 is emulated as a virtual disk by the virtual disk interface controller 401a and presented to the data processor 401. The apparatus is to operate within and on a computer system comprising the hardware components of at least one main processor and at least one storage device, typically a central processing unit (CPU) 441 and a random access memory (RAM) 442.

The data processor 401 further includes a disk interface 401b. A virtual disk emulated by the virtual disk interface controller 401a is presented to the data processor 401 via a disk interface bus 405 to the disk interface 401b as response to the data processor 401.

The storage subsystem 402 includes a plurality of data storage devices 421˜42n, a virtual disk image manager 402a, and a virtual disk image transporter 402b. The virtual disk interface controller 401a communicates with the virtual disk image transporter 402b via the network 403. Each data storage device contains data blocks that are constructed into a plurality of virtual disk images 4021˜402m by the virtual disk image manager 402a under the instruction from a user interface 407. The virtual disk image transporter 402b accesses a data storage device for the data blocks comprising the selected virtual disk image via a map maintained by the virtual disk image manager 402a and communicates with the virtual disk interface controller 401a via the network 403.

According to the invention, each virtual disk image comprises a set of sequentially numbered blocks of data storage of predetermined fixed size. The data storage subsystem 402 may include a cache memory for storing most recently used blocks for the data processor 401. The data storage subsystem 402 may also include a selection unit to select one of the virtual disk images via the map maintained by the virtual disk image manager 402a.

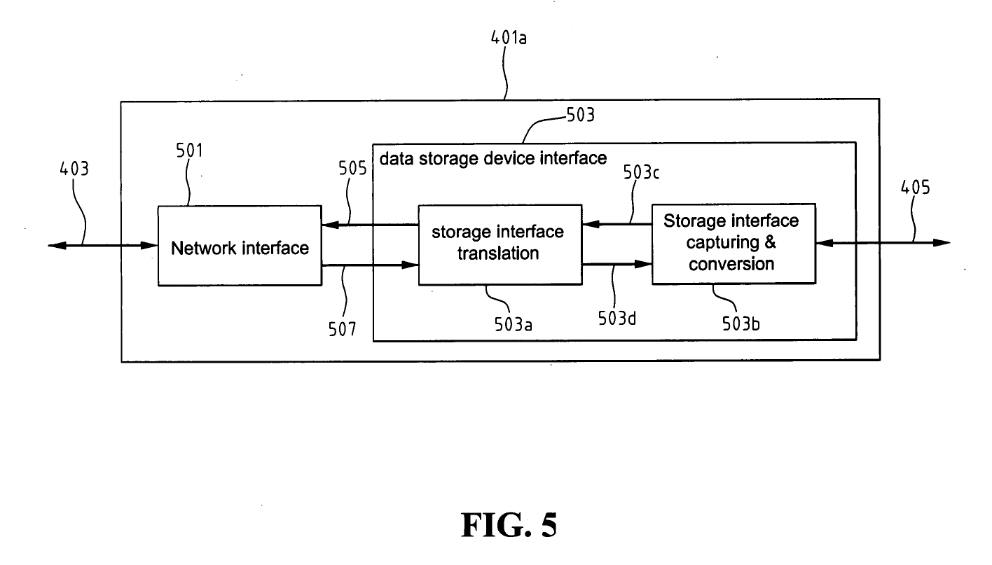

Based on FIG. 4, the operation of the virtual disk interface controller 401a between the disk interface 401b and the data storage subsystem 402 is illustrated by the disk access during bootstrapping an operating system. First, the data processor 401 sends out a load-the-MBR command via the disk interface 401b. The disk interface 401b converts the command into electronic signals to be picked up by the virtual disk interface controller 401a wherein the signals are reassembled into digitally encoded command. The command is prepared by a storage interface translating unit (shown in FIG. 5) in the virtual disk interface controller 401a in the form of a network packet, so that it can be transported over the network 403 to the data storage subsystem 401. The virtual disk image transporter 402b including a network receiving and sending module (not shown) then picks up the packet and decodes for the command.

The virtual disk image transporter 402b is also responsible for interpreting special disk access command, such as the load-the-MBR command, and providing special responses. In this invention, a special response is a special interactive choose-disk-image-and-use-it loader program. The special loader program is executed by the data processor 401 and receives a list of available disk image candidates by name collected by the data storage subsystem 402. The special loader program displays the list of disk image names for users to select from. The data storage subsystem 402 is informed of the selected disk image. Accordingly, a network communication channel is established to link to the data processor 401 for its subsequent disk access requests and responses.

Each disk access requested by the data processor 401 goes through the same route to reach the data storage subsystem 402. It is noted that the virtual disk image transporter 402b accesses a data storage device for blocks comprising the selected virtual disk image via a map maintained by the virtual disk image manager 402a. The virtual disk image blocks are read per data processor's requests and prepared by the virtual disk image transporter 402b in the form of network packets that are transported over the network 403 back to the data processor 401.

Upon receiving the network packets from the data storage subsystem 402, the virtual disk interface controller 401a de-translates the packets into disk interface stream data that will further be converted into electronic signals for sending over the disk interface bus 405 to the disk interface 401b, thereby accomplishing the data processor's disk access request cycle.

FIG. 5 shows a more detailed diagram for the virtual disk interface controller 401a according to the present invention. As can be seen form FIG. 5, the virtual disk interface controller 401a includes a network interface 501 and a data storage device interface 503. The data storage device interface 503 captures and interprets the data access requests via the disk interface bus 405, then converts the interpreted requests for sending back to the data processor. The data storage device interface 503 may include a storage interface translation unit 503a and a storage interface capturing and conversion unit 503b. The storage interface capturing and conversion unit 503b captures storage interface commands via the disk interface bus 405 and sent the storage interface commands 503c to the storage interface translation unit 503a for translation. The translated commands 505 are sent via the network interface 501 over the network 403 to the data storage subsystem 402 where data storage accesses take place physically. The results 507, after being received via the network interface 501, are translated into a storage interface format 503d by the storage interface translation unit 503a. The storage interface capturing and conversion unit 503b converts the translated results coming back from the data storage subsystem 402 and sends via the disk interface bus 405 to the disk interface 401b in the data processor 401. Thereby, the results after conversion are ready for use by the data processor 401.

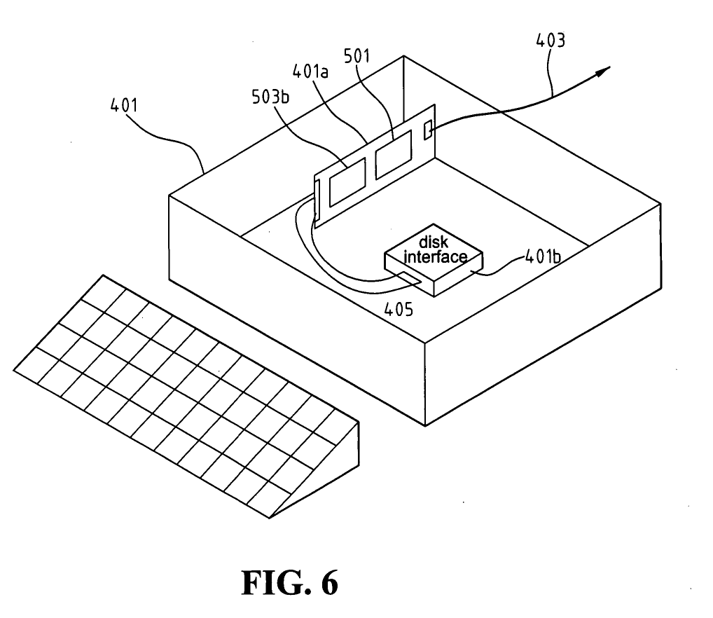

FIG. 6 shows a simplified representative diagram for the data processor 401 connected to the network 403, where the virtual disk interface controller 401a and the disk interface 401b are connected together via the disk interface bus 405. In FIG. 6, the disk interface capturing and conversion unit 503b and the network interface 501 are also shown.

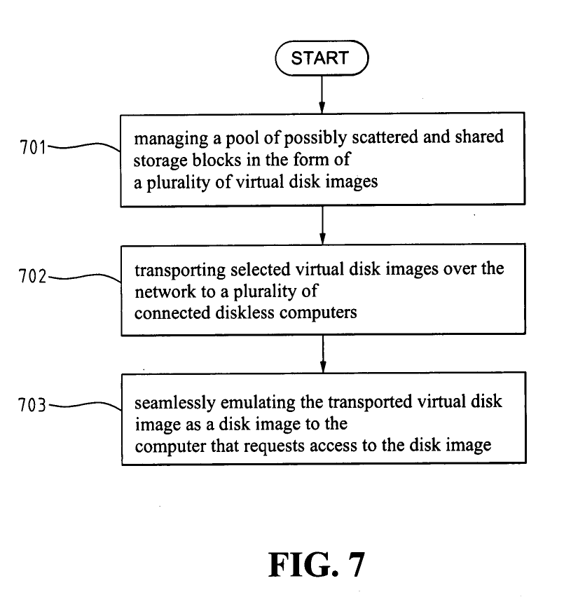

From the above description, the accompanying method for managing and transporting virtual disks over a network to networked stations of the present invention can be summarized as shown in FIG. 7. Referring to FIG. 7, the method includes three steps: (step 701) managing a pool of possibly scattered and shared storage blocks in the form of a plurality of virtual disk images, (step 702) transporting selected virtual disk images over the network to a plurality of connected diskless computers, and (step 703) seamlessly emulating the transported virtual disk image as a disk image to the computer that requests access to the disk image, where a disk image is transparently subject to local hard disk manipulation utilities for making partitions, creating file system or configuring for bootstrapping, and each emulating performs the function of a disk emulator that serves as a local disk device to its host computer. The disk image functions in the same way as the local hard disk without noticeable difference to the computer that hosts the disk emulation adaptor. The disk emulation adaptor communicates with the disk image server via a network protocol for transporting packets that encapsulate disk access requests and results.

With reference to the figures and more specifically to FIG. 4, there is an illustrative embodiment of a network environment in which the present invention may be utilized advantageously. In the followings, the detailed operation procedures for the PC to utilize the present invention will be illustrated.

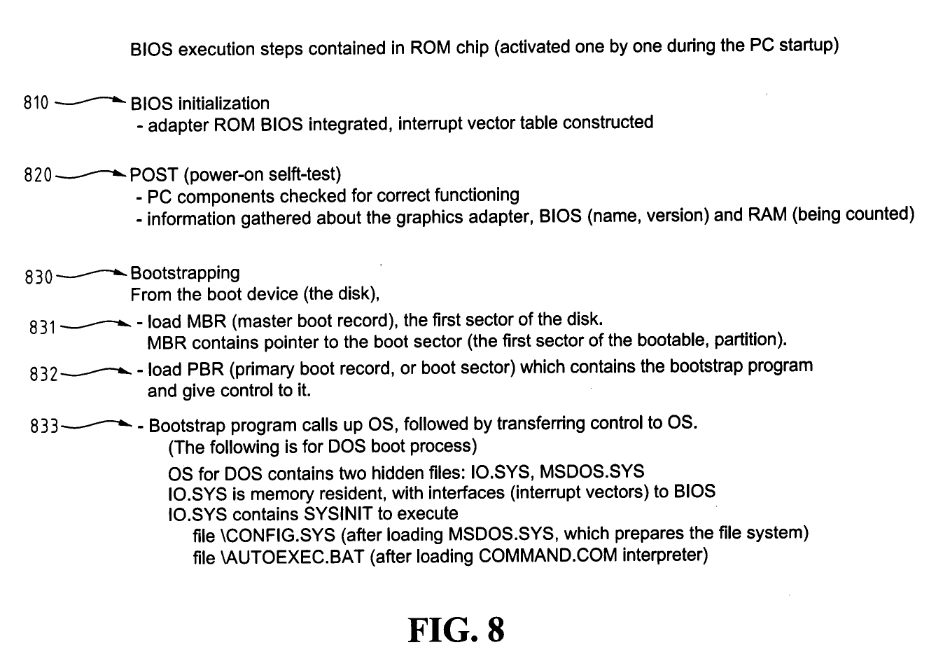

The first step of starting a PC is to power it on. FIG. 8 shows a PC boot process. As illustrated in FIG. 8, successful execution of the normal BIOS initialization (step 810) and POST stage (step 820) after the power is switched on will bring the PC (shown as the data processor 401) to the stage (step 830) where special blocks on the storage device (or disk for short) will be accessed for instructions on how to properly load up the operating system. The disk access commands will be captured and transported over the network to the data storage subsystem 402. In the present invention, the data storage subsystem 402 first responds to the load-the-MBR command 831 with a special boot record that is executed by requesting data processor 401 to establish a boot management session 832 in which the designated disk images are listed by name for selection. After the desired disk image has been identified, the data storage subsystem 402 follows normal booting process, starting with requesting and executing the primary boot sector code of the activated partition if that partition contains a valid primary boot sector. Subsequently will be loaded and executed some varying OS-bootstrapping codes, depending on the type of the operating system installed on the active partition. The step 833 in FIG. 8 displays a version of bootstrapping the Microsoft DOS.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. An apparatus for managing and transporting virtual disks over a network to networked stations comprises a data storage subsystem and at least one data processor connected thereto via a network, said data processor includes a virtual disk interface controller to interface with said storage subsystem in handling the input and output for said storage subsystem, and said storage subsystem manages a pool of storage blocks in the form of a plurality of virtual disk images and transports the virtual disk images over the network to said virtual disk interface controller, wherein each virtual disk image transported via the network is emulated as a virtual disk by said virtual disk interface controller and presented to said data processor.

2. The apparatus for managing and transporting virtual disks over a network to networked stations as claimed in claim 1, wherein said storage subsystem further comprises a virtual disk image manager, a plurality of data storage devices, and a virtual disk image transporter, each data storage device contains data blocks that are constructed into a plurality of virtual disk images by said virtual disk image manager under the instruction from a user interface, said virtual disk image transporter accesses a data storage device for said data blocks comprising the selected virtual disk image via a map maintained by said virtual disk image manager and communicates with said virtual disk interface controller via the network.

3. The apparatus for managing and transporting virtual disks over a network to networked stations as claimed in claim 1, wherein said data processor further includes a disk interface, a virtual disk emulated by said virtual disk interface controller is presented to said data processor via a disk interface bus to said disk interface as response to said data processor.

4. The apparatus for managing and transporting virtual disks over a network to networked stations as claimed in claim 1, said virtual disk interface controller further comprising:
a data storage device interface for capturing and interpreting the data access requests via a disk interface bus, then converting the interpreted requests for sending back to said data processor; and
a network interface for conducting data storage interfacing via the network with said data storage subsystem.

5. The apparatus for managing and transporting virtual disks over a network to networked stations as claimed in claim 4, said data storage device interface further comprising:
a storage interface capturing and conversion unit for capturing storage interface 5 commands via the disk interface bus for translation, and the results coming back from said data storage subsystem being converted for sending back to said data processor; and
a storage interface translation unit for translating captured storage interface commands into a storage interface format, and the translated commands being sent via said network interface over the network to said data storage subsystem where data storage accesses take place physically.

6. The apparatus for managing and transporting virtual disks over a network to networked stations as claimed in claim 2, wherein each virtual disk image comprises a set of sequentially numbered blocks of data storage of predetermined fixed size.

7. The apparatus for managing and transporting virtual disks over a network to networked stations as claimed in claim 2, wherein said data storage subsystem further includes a cache memory for storing most recently used blocks for said data processor.

8. The apparatus for managing and transporting virtual disks over a network to networked stations as claimed in claim 2, wherein said data storage subsystem further includes a selection unit to select one of said virtual disk images via the map maintained by said virtual disk image manager.

9. The apparatus for managing and transporting virtual disks over a network to networked stations as claimed in claim 1, wherein said apparatus is to operate within and on a computer system comprising the hardware components of at least one main processor and at least one storage device.

10. A data processor for managing and transporting virtual disks over a network to networked stations, comprising:
a virtual disk interface controller to interface with a storage subsystem having a plurality of virtual disk images in handling the input and output for the storage subsystem; and
a disk interface, a virtual disk image emulated by said virtual disk interface controller is presented to said data processor via a disk interface bus to said disk interface as response to said data processor.

11. The data processor for managing and transporting virtual disks over a network to networked stations as claimed in claim 10, said virtual disk interface controller further comprising:
a data storage device interface for capturing and interpreting the data access requests via said disk interface bus, then converting the interpreted requests for sending back to said data processor; and
a network interface for conducting data storage interfacing via the network with the data storage subsystem.

12. The data processor for managing and transporting virtual disks over a network to networked stations as claimed in claim 11, said data storage device interface further comprising:
a storage interface capturing and conversion unit for capturing storage interface commands via the disk interface bus for translation, and the results coming back from the data storage subsystem being converted for sending back to said data processor; and
a storage interface translation unit for translating captured storage interface commands into a storage interface format, and the translated commands being sent via said network interface over the network to the data storage subsystem where data storage accesses take place physically.

13. A method for managing and transporting virtual disks over a network to networked stations, comprising the steps of: (a) managing a pool of possibly scattered and shared storage blocks in the form of a plurality of virtual disk images, (b) transporting selected virtual disk images over the network to a plurality of connected diskless computers and (c) seamlessly emulating the transported virtual disk image as a disk image to the computer that requests access to the virtual disk image.

14. The method for managing and transporting virtual disks over a network to networked stations as claimed in claim 13, wherein the step (a) further comprises the steps of:
(a1) creating said plurality of virtual disk images in block format, each virtual disk image comprising a set of sequentially numbered blocks of data storage of predetermined fixed size; and
(a2) accessing data blocks of selected virtual disk from said virtual disk images via a map maintained by a virtual disk image manager.

15. The method for managing and transporting virtual disks over a network to networked stations as claimed in claim 13, wherein a disk image in the step (c) is transparently subject to local hard disk manipulation utilities for making partitions, creating file system or configuring for bootstrapping.

16. The method for managing and transporting virtual disks over a network to networked stations as claimed in claim 13, wherein each emulation unit in the step (c) performs the function of a disk emulator that serves as a local disk device to its host computer, and the communication between a disk emulation adaptor and a disk image server is via a network protocol for transporting packets that encapsulate disk access requests and results.
